(19) United States
(12) Patent Application Publication
(10) Pub. No.: US 2013/0271255 A1
(43) Pub. Date: Oct. 17, 2013

(54) CIRCUIT PROTECTION DEVICE

(71) Applicant: INNOCHIPS TECHNOLOGY CO., LTD, Ansan-Si (KR)

(72) Inventors: In-Kil PARK, Yongin-Si (KR); Tae-Hyung NOH, Siheung-Si (KR); Gyeong-Tae KIM, Ansan-Si (KR); Ki-Joung NAM, Siheung-Si (KR); Hyun-Sik KIM, Bucheon-Si (KR)

(73) Assignee: Innochips Technology Co., Ltd, Ansan-Si (KR)

(21) Appl. No.: 13/862,401

(22) Filed: Apr. 13, 2013

(30) Foreign Application Priority Data
Apr. 17, 2012 (KR) 10-2012-0039645

(51) Int. Cl. H01F 38/00

(52) U.S. Cl. CPC H01F 38/00
USPC 336/200

(57) ABSTRACT

The present invention relates to a circuit protection device and provides a circuit protection device comprising a laminate having a plurality of sheets laminated; a magnetic core provided within the laminate; a coil provided within the laminate and configured to wind vertically and to wrap the magnetic core; a projecting electrode connected to the coil and projected to be exposed to the outside of the laminate; and an external electrode provided on the laminate and connected to the projecting electrode.

### CROSS-REFERENCE TO RELATED APPLICATION

This application claims priority to Korean Patent Application Nos. 10-2012-0039645 filed on Apr. 17, 2012 and the benefits accruing therefrom under 35 U.S.C. 119, the contents of which are herein incorporated by reference in its entirety.

### TECHNICAL FIELD

The present invention relates to a circuit protection device, and more particularly to circuit protection device to suppress noises in electronic devices.

### BACKGROUND

Recently, various frequency bands have been used according to the multi-functionality of portable electronic devices, for example smart phones. That is, different frequency bands are used for wireless LAN, bluetooth, GPS, etc. in one smart phone. In particular, more strict regulation has been applied to EMI (Electro-magnetic Interference) to avoid an influence on communications using GHz frequency bands such as wireless LAN and GPS. In fact, EMI has been regulated by up to 6 GHz in Europe and Japan since October 2010, and therefore EMI more than 1 GHz should be restricted. Further, as such electronic devices are highly integrated, the density of inner circuits is increased in a limited space. Therefore, noise interference between inner circuits is essentially generated.

To suppress noises from such various frequencies and noises between inner circuits, a plurality of circuit protection devices have been used. For example, a condenser, a chip bead, a common mode filter and the like have been used to eliminate noises from different frequency bands. A common mode filter has a structure that two choke coils are integrated as one piece. It eliminates common mode noise currents, but passes differential mode signal currents. That is, a common mode filter may separate common mode noise currents from differential mode signal currents that are alternating currents and eliminate the common mode noise currents.

Further, a chip bead is a type of parts developed using ferrite to solve noises. It is an electronic part having a simple structure that a coil having several turns is formed at a center of ferritic material. When a signal passes a coil of chip bead, high frequency noise components included in the signal are eliminated. A chip bead eliminates noises using impedance property which increase proportionally to frequency. In a chip bead, signals are passed using inductor of the coil as a major component up to a desired frequency range, while noises are absorbed using resistance as a major component in higher frequency range. The absorbed noises are converted to heat.

However, a conventional chip bead fails to achieve such impedance property in high frequency band. That is, such a chip bead shows impedance property up to about 100 MHz, but it does not show impedance property in GHz frequency. Therefore, a conventional chip bead cannot eliminate noises generated in electronic devices such as smart phones using various high frequency bands.

### SUMMARY

### Problems to be Solved

It is an object of the present invention to provide a circuit protection device which can improve high frequency impedance property and reduce DC resistance.

It is another object of the present invention to provide a circuit protection device which can improve high frequency impedance property wherein a magnetic core having different magnetic permeability are formed and a coil wrapping the core is formed.

It is further object of the present invention to provide a circuit protection device wherein the thickness of coil patterns is increased to reduce DC resistance and to minimize electric power loss generated in a circuit.

### Means to Solve the Problems

According to an aspect of the present invention, a circuit protection device comprises a laminate having a plurality of sheets laminated; a magnetic core provided within the laminate; a coil provided within the laminate and configured to wind vertically and to wrap the magnetic core; a projecting electrode connected to the coil and projected to be exposed to the outside of the laminate; and an external electrode provided on the laminate and connected to the projecting electrode.

The magnetic core is formed by interconnecting first holes filled with a magnetic material in a plurality of selected sheets.

The coil is formed by forming a plurality of coil patterns and second holes filled with a conductive material, connected with the plurality of coil patterns, respectively, in a plurality of selected sheets, and by interconnecting the plurality of coil patterns by the second holes filled with a conductive material.

The coil patterns may be formed in patterned sheets formed on the sheets, or in grooves formed in the sheets.

The coil patterns, the first holes filled with a magnetic material and the second holes filled with a conductive material are individually formed on a plurality of selected sheets, the first holes filled with a magnetic material are interconnected to form the magnetic core, and the coil patterns are interconnected by the second holes filled with a conductive material to form the coil.

The plurality of sheets and the magnetic core have different magnetic permeability, and the magnetic core has magnetic permeability higher than or lower than that of the plurality of sheets.

According to another aspect of the present invention, a circuit protection device comprises a plurality of sheets; first holes filled with a magnetic material formed in each of sheets selected among the plurality of sheets; coil patterns; and second holes filled with a conductive material, wherein the first holes filled with a magnetic material are interconnected to form a magnetic core, and the coil patterns are interconnected by the second holes filled with a conductive material to form a coil.

The circuit protection device further comprises a projecting electrode connected to the coil and exposed to outside through the laminate, and an external electrode provided on the laminate and connected to the projecting electrode.

### Effect of the Invention

The circuit protection device according to aspects of the present invention can improve high frequency impedance property by forming a magnetic core by holes filled with a magnetic material within a laminate having a plurality of sheets laminated, and forming a coil configured to rotate vertically and to wrap the magnetic core by coil patterns and holes filled with a conductive material formed on the plurality of sheets. That is, high frequency impedance property can be improved by providing a magnetic core having magnetic permeability different from sheets and forming a coil wrapping the core.

In addition, DC resistance can be reduced by increasing the thickness of coil patterns which form the coil.

### BRIEF DESCRIPTION OF THE DRAWING

FIG. 1 is a perspective view of a circuit protection device according to an embodiment of the present invention.

FIG. 2 is a cross-sectional view of a circuit protection device according to an embodiment of the present invention.

FIG. 3 is an exploded perspective view of a circuit protection device according to an embodiment of the present invention.

FIG. 4 is an impedance graph of a circuit protection device according to an embodiment of the present invention.

FIG. 5 is an exploded perspective view of a circuit protection device according to another embodiment of the present invention.

FIG. 6 is an exploded perspective view of a circuit protection device according to further embodiment of the present invention.

### DETAILED DESCRIPTION

Now, embodiments according to the present invention will be described in detail with reference to the accompanying drawings. However, the present invention is not limited to these embodiments described below, but it may be implemented as various different configurations. These embodiments are provided for a full understanding of the present invention, and the scope of the present invention may be fully understood by one with ordinary skill in the art with reference to these embodiments. A thickness in the drawings is enlarged to show clearly a variety of layers and regions. Like numbers in the drawings represent like elements.

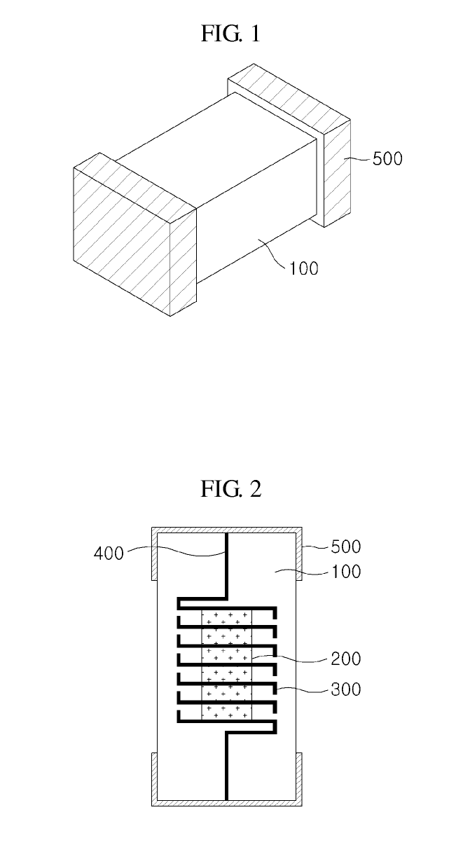

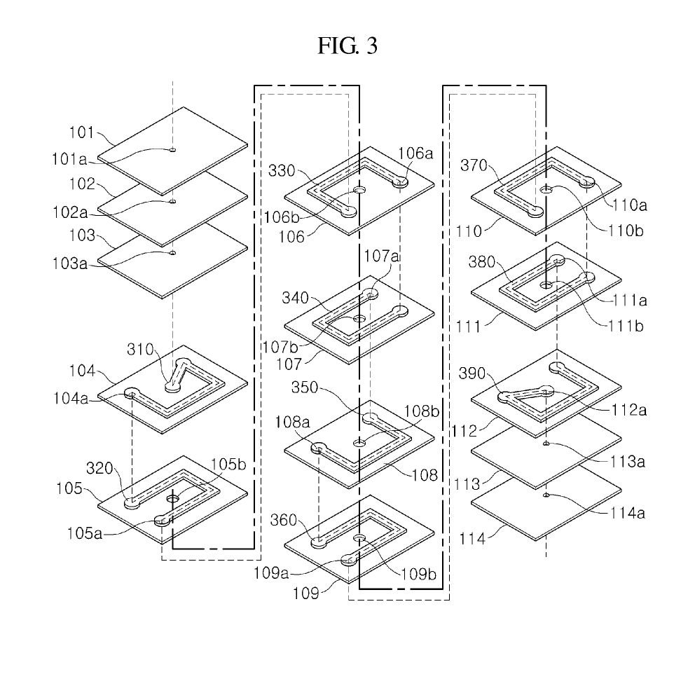

FIG. 1 is a perspective view a chip bead as a circuit protection device according to an embodiment of the present invention, FIG. 2 is a cross-sectional view thereof, and FIG. 3 is an exploded perspective view thereof.

Referring to FIGS. 1 and 2, the circuit protection device according to an embodiment of the present invention comprises a laminate 100 having a plurality of sheets 101 to 114 laminated; a magnetic core 200 provided at a center region within the laminate 100; a coil 300 provided within the laminate 100 and configured to wind vertically and to wrap the magnetic core 200; a projecting electrode 400 connected to the coil 300 and projected toward outside; and an external electrode 500 provided in the outside of the laminate 100 and connected to the projecting electrode 400 exposed to outside.

Now, the circuit protection device according to an embodiment of the present invention will be described in detail with reference to the exploded perspective view of FIG. 3.

As shown in FIG. 3, the circuit protection device comprises a plurality of sheets 101 to 114, the projecting electrode 400 formed by filling a conductive material in holes 101a, 102a, 103a, 113a, 114a formed on selected sheets 101, 102, 103, 113, 114, the magnetic core 200 formed by filling a magnetic material in holes 105b to 111b formed on selected sheets 105 to 111, the coil 300 formed by coil patterns 310 to 390 which are interconnected by holes 104a to 111a filled with a conductive material, which are formed on selected sheets 104 to 112 and spaced apart from the holes 105b to 111b, and the external electrode 500 connected to the projecting electrode 400 exposed to outside. The plurality of sheets 101 to 114 may be made from ferritic ceramic having a desired magnetic permeability. Hereinafter, holes will be represented by different signs according to materials filled in holes, even when designating holes formed at the same position in different sheets. That is, holes filled with a conductive material are represented by “a” in figures, and holes filled with a magnetic material are represented by “b” in figures.

A plurality of sheets in an upper portion, for example at least three sheets 101, 102, 103 have holes 101a, 102a, 103a formed at a desired region, preferably center regions of the sheets, and a conductive material is filled in the holes 101a, 102a, 103a. The conductive material may use a metallic material such as Ag, Pt and Pd. Also, it may be possible to fill holes 101a, 102a, 103a, 112a, 113a, 114a using a paste of metallic material. As a result, the projecting electrode 400 is formed vertically, which is exposed from inside to outside. That is, the projecting electrode 400 is formed such that it passes through the center regions of the plurality of laminated sheets 101, 102, 103 and is exposed to outside. In other words, the projecting electrode 400 is formed in a direction that the plurality of sheets 101, 102, 103 are laminated. For example, when the plurality of sheets 101, 102, 103 are laminated in a vertical direction, the projecting electrode 400 is formed in the vertical direction by passing through the plurality of sheets 101, 102, 103.

The coil pattern 310 and hole 104a are formed in the sheet 104. The coil pattern 310 is formed from a region corresponding to the hole 103a in the sheet 103 in one direction according to a shape of the sheet 104. For example, the coil pattern 310 extends straightly from a center region of the sheet 104 to outside, for example to one corner direction of the sheet 104, and is formed as a desired shape along a selected side of the sheet 104 therefrom. For example, the coil pattern 310 may be formed as approximately a “ [symbol] ”-like shape along three sides of the sheet 104. That is, the coil pattern 310 comprises a region extending from the center region to outside and is formed along three sides of the sheet 104, for example in clockwise direction therefrom. In addition, the coil pattern 310 may be formed as various shapes such as approximately “ [symbol] -”-like and “ [symbol] ”-like shapes other than approximately “ [symbol] ”-like shape, but one end and the other end of the coil pattern may be spaced apart from each other. The hole 104a is formed at the other end of the coil pattern 310, which is a point where the coil pattern 310 is terminated. Then, a conductive material is filled in the hole 104a. For example, a paste of metallic material may be filled.

The coil patterns 320 to 380, the holes 105a to 111a filled with a conductive material and the holes 105b to 111b filled with a magnetic material are formed on each of a plurality of sheets 105 to 111. The holes 105b to 111b are formed at a center region of each of the sheets 105 to 111 and have a magnetic material filled therein. For example, a magnetic paste may be filled in the holes 105b to 111b. The magnetic paste may include pastes such as ferritic, Ni-based, Ni—Zn-based and Ni—Zn—Cu-based pastes having magnetic permeability different from the sheets 101 to 114 of the laminate 100. The magnetic material filled in the holes 105b to 111b may have magnetic permeability higher than or lower than that of the sheets 104 to 114. These holes 105b to 111b filled with a magnetic material are laminated to form the magnetic core 200 at the center regions of the plurality of sheets 105 to 111. The holes 105a to 111a are formed at different positions in each of the sheets 105 to 111. For example, the hole 105a of the sheet 105 is formed at a region corresponding to a corner region between a first side and a second side, and the hole 106a of the sheet 106 is formed at a region corresponding to a corner region between the second side and a third side. As such, the holes 105a to 111a are formed at a corner region of each sheet 105 to 111 while rotating in clockwise direction. A conductive material is filled in these holes 105a to 111a. Further, the holes 105b to 111b filled with a magnetic material have a diameter greater than or equal to that of the holes 105a to 111a filled with a conductive material, and the holes 105b to 111b are preferably greater than the holes 105a to 111a. The coil patterns 320 to 380 are formed as a desired shape from regions corresponding to the holes 104a to 110a of each sheet 104 to 110 in the upper portion along sides of each sheet 105 to 111 and spaced apart from the holes 105b to 111b filled with a magnetic material at a desired distance. For example, the coil patterns 320 to 380 are formed from the holes 105a to 111b along three sides of the sheets 105 to 111 in one direction, for example in clockwise direction to form a “ [symbol] ”-like shape. These may be formed as various shapes such as approximately “ [symbol] -”-like and “ [symbol] ”-like shapes. However, the coil patterns 320 to 380 may be formed such that one end and the other end are spaced apart from each other. In addition, the holes 105a to 111a filled with a conductive material are formed at each of the other ends of the coil patterns 320 to 380. As a result, the coil patterns 320 to 380 formed on the plurality of sheets 105 to 111 are interconnected by the holes 105a to 111a to wrap the holes 105b to 111b filled with a magnetic material and to form the coil 300 having a plurality of turns. That is, the coil is formed with wrapping the magnetic core 200. In this case, as a distance between the magnetic core 200 and the coil 300 is decreased, impedance to higher frequency is imparted. Therefore, a distance between the magnetic core 200 and the coil 300 may be adjusted depending on the desired high frequency band. Moreover, when one of each coil pattern 310 to 390 forms one turn, respectively, the coil 300 may have 18 to 35 turns, for example. Therefore, the number of the sheets 104 to 112 on which the coil patterns 310 to 390 are formed may be adjusted depending on the desired number of turns.

The coil pattern 390 and hole 112a are formed in the sheet 112. The coil pattern 390 is formed from a region corresponding to the hole 111a in the sheet 111 in one direction according to a shape of the sheet 112. For example, the coil pattern 390 is formed as a desired shape from one corner region of the sheet 112 along a selected side of the sheet 112 in one direction, for example in clockwise direction, and extends to a center region therefrom. That is, the coil pattern 390 comprises a region formed as approximately a “ [symbol] ”-like shape along three sides of the sheet 112 in clockwise direction and a region extending from the center region to inside. In addition, the coil pattern 390 may be formed as various shapes such as approximately “ [symbol] ”-like and “ [symbol] ”-like shapes other than approximately “ [symbol] ”-like shape, but one end and the other end of the coil pattern may be spaced apart from each other. The hole 112a is formed at the other end of the coil pattern 390, which is a center region of the sheet 112 where the coil pattern 390 is terminated. Then, a paste of metallic material may be filled in the hole 112a.

A plurality of sheets in a lower portion, for example at least two sheets 113 and 114 have holes 113a and 114a formed at a desired region, preferably center regions of the sheets, and a conductive material is filled in the holes 113a and 114a. The conductive material may use a paste of metallic material such as Ag, Pt and Pd. As a result, the projecting electrode 400 is formed, which is exposed from inside to outside. That is, the projecting electrode 400 is formed such that it passes through the center regions of the plurality of laminated sheets 113 and 114 and is exposed to outside.

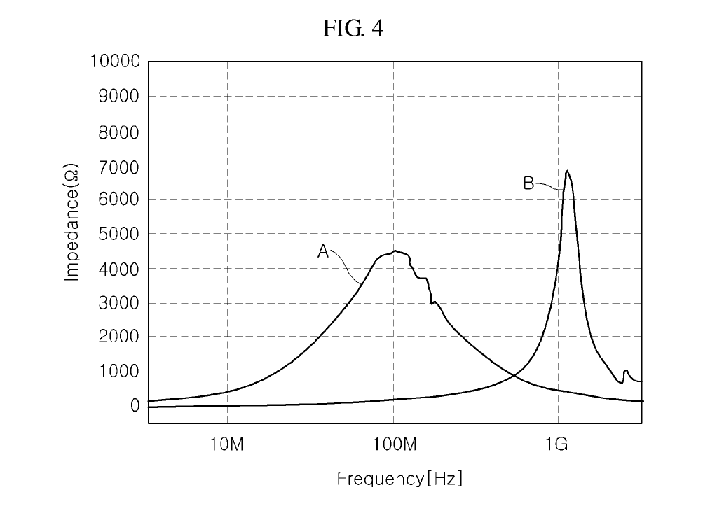

As described above, the circuit protection device according to an embodiment of the present invention, that is, a chip bead comprises the magnetic core 200 formed by the holes 105b to 111b filled with a magnetic material in a center region within the laminate 100 having the plurality of laminated sheets 101 to 114 and the coil 300 formed by the coil patterns 310 to 390 and the holes 104a to 112a filled with a conductive material to rotate vertically and to wrap the magnetic core 200. The magnetic core 200 has magnetic permeability different from the sheets 101 to 114. That is, the magnetic core 200 having a second magnetic permeability is formed at the center regions of the plurality of sheets 101 to 114 having a first magnetic permeability, and the coil 300 is formed to wrap the magnetic core. As a result, the circuit protection device according to the present invention can improve high frequency impedance property. That is, as shown in FIG. 4, the impedance property of the circuit protection device A without a magnetic core is about 100 MHz, while the impedance property of the circuit protection device B with a magnetic core is about 1 MHz. Thus, it was demonstrated that the circuit protection device with a magnetic core could improve high frequency impedance property.

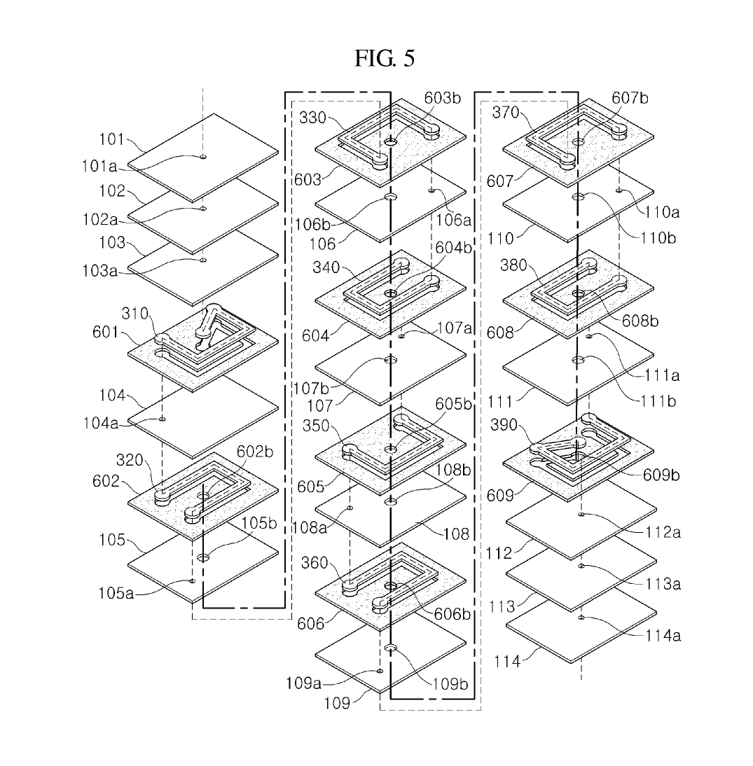

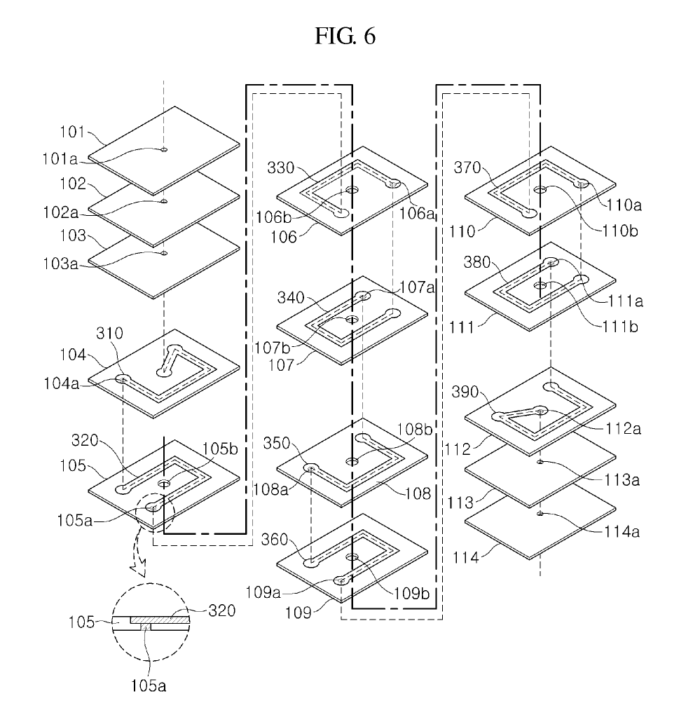

FIG. 5 is an exploded perspective view of a circuit protection device according to another embodiment of the present invention.

Referring to FIG. 5, the circuit protection device according to another embodiment of the present invention comprises a plurality of sheets 101 to 114; a projecting electrode 400 formed by filling holes 101a, 102a, 103a, 113a, 114a formed on selected sheets 101, 102, 103, 113, 114 with a conductive material; a magnetic core 200 formed by filling holes 105b to 111b formed on selected sheets 105 to 111 with a magnetic material; a coil 300 formed by coil patterns 310 to 390 which are interconnected by holes 104a to 111a filled with a conductive material, which are formed on selected sheets 104 to 112 and spaced apart from the holes 105b to 111b; and an external electrode 500 connected to the projecting electrode exposed to outside. Also, the device comprises patterned sheets 601 to 609 on which shapes of the coil patterns 310 to 390 are engraved, which are provided on the selected sheets 104 to 112 to form the coil patterns 310 to 390. The patterned sheets 601 to 609 may be made from the same material as the sheets 101 to 114, for example ferritic ceramic.

A plurality of sheets in an upper portion, for example at least three sheets 101, 102, 103 have holes 101a, 102a, 103a formed at center regions of the sheets, and a paste of metallic material is filled in the holes 101a, 102a, 103a. As a result, the projecting electrode 400 is formed vertically, which is exposed from inside to outside. That is, the projecting electrode 400 is formed such that it passes through the center regions of the plurality of sheets 101, 102, 103 and is exposed to outside.

The coil pattern 310 and hole 104a are formed in the sheet 104. The coil pattern 310 is formed using the patterned sheet 601 provided on the sheet 104. An engraved pattern is formed as a desired shape in the pattern sheet 601, and a paste of metallic material is filled in the engraved pattern to form the coil pattern 310. That is, the patterned sheet 601 having a desired pattern engraved is placed on the sheet 104, the patterned sheet 601 and the sheet 104 are bonded to each other by a desired pressure and heat, and a conductive material is filled in the engraved pattern of the patterned sheet 601 to form the coil pattern 310. The patterned sheet 601 may have a size equal to that of the sheet 104 and a thickness corresponding to a thickness of the coil pattern 310. As such, since the sheet 104 and the patterned sheet 601 that the coil pattern 310 is formed are separately prepared, the thickness of the coil pattern 310 may be larger than that of the coil pattern formed on the sheet 104. Further, the thickness of the coil pattern 310 may be adjusted by controlling the thickness of the patterned sheet 601. The coil pattern 310 is formed from a region corresponding to the hole 103a in the sheet 103 in one direction according to a shape of the sheet 104. For example, the coil pattern 310 extends straightly from a center region of the sheet 104 to outside, for example to one corner direction of the sheet 104, and is formed as a desired shape along a selected side of the sheet 104 therefrom. The hole 104a is formed at the other end of the coil pattern 310, which is a point where the coil pattern 310 is terminated. Then, a paste of metallic material is filled in the hole 104a.

The coil patterns 320 to 380, the holes 105a to 111a filled with a conductive material and the holes 105b to 111b filled with a magnetic material are formed on each of a plurality of sheets 105 to 111. The patterned sheets 602 to 608 are provided onto each of the plurality of sheets 105 to 111. Engraved patterns are formed as a desired shape in the pattern sheets 602 to 608, and a paste of metallic material is filled in the engraved patterns to form the coil patterns 320 to 380. That is, the patterned sheets 602 to 608 having a desired pattern engraved are placed on the plurality of sheets 105 to 111, respectively, the patterned sheets 602 to 608 and the sheets 105 to 111 are bonded to each other by a desired pressure and heat, respectively, and a conductive material is filled in the engraved patterns of the patterned sheets 602 to 608 to form the coil patterns 320 to 380, respectively. The patterned sheets 602 to 608 may have a size equal to that of the sheets 105 to 111 and a thickness corresponding to a thickness of the coil patterns 320 to 380. Therefore, the thickness of the coil patterns 320 to 380 is formed as the thickness of the patterned sheets 602 to 608. As such, since the sheets 105 to 111 and the patterned sheets 602 to 608 that the coil patterns 320 to 380 are formed are separately prepared, the thickness of the coil patterns 320 to 380 may be larger than that of the coil patterns formed on the sheets 105 to 111. Further, the thickness of the coil patterns 320 to 380 may be adjusted by controlling the thickness of the patterned sheets 602 to 608. The holes 602b to 608b are formed at center regions of the patterned sheets 602 to 608, that are regions corresponding to the holes 105b to 111b of the sheets 105 to 111 and have a magnetic material filled therein. As a result, the holes 105b to 111b of the plurality of sheets 105 to 111 and the holes 602a to 608b of the patterned sheets 602 to 608, which are filled with a magnetic material, are interconnected to form the magnetic core 200. The holes 105a to 111a are formed at different positions in each of the sheets 105 to 111. For example, the holes 105a to 111a are formed at a corner region of each sheet 105 to 111 while rotating in clockwise direction. A conductive material is filled in these holes 105a to 111a. The coil patterns 320 to 380 are formed as a desired shape from regions corresponding to the holes 104a to 110a of each sheet 104 to 110 in the upper portion along sides of each sheet 105 to 111 and spaced apart from the holes 105b to 111b filled with a magnetic material at a desired distance. For example, the coil patterns 320 to 380 are formed from the holes 105a to 111b along three sides of the sheets 105 to 111 in one direction, for example in clockwise direction to form a “ [symbol] ”-like shape. In addition, the holes 105a to 111a filled with a conductive material are formed at each of the other ends of the coil patterns 320 to 380. As a result, the coil patterns 320 to 380 formed on the plurality of sheets 105 to 111 are interconnected by the holes 105a to 111a to wrap the holes 105b to 111b filled with a magnetic material and to form the coil 300 having a plurality of turns. That is, the coil is formed with wrapping the magnetic core 200.

The coil pattern 390 and hole 112a are formed in the sheet 112. The coil pattern 390 is formed using the patterned sheet 609 provided on the sheet 112. That is, an engraved pattern is formed as a shape of the coil pattern 390 in the pattern sheet 609, and a paste of metallic material is filled in the engraved pattern to form the coil pattern 390. The patterned sheet 609 may have a size equal to that of the sheet 112 and a thickness corresponding to a thickness of the coil pattern 390. Therefore, the thickness of the coil pattern 390 is formed as the thickness of the patterned sheet 609. The coil pattern 390 is formed from a region corresponding to the hole 111a in the sheet 111 in one direction according to a shape of the sheet 112. For example, the coil pattern 390 is formed as a desired shape from one corner region of the sheet 112 along a selected side of the sheet 112, for example in clockwise direction, and extends to a center region therefrom. That is, the coil pattern 390 comprises a region formed as approximately a “ [symbol] ”-like shape along three sides of the sheet 112 in clockwise direction and a region extending from the center region to inside. The hole 112a is formed at the other end of the coil pattern 390, which is a center region of the sheet 112 where the coil pattern 390 is terminated. Then, a paste of metallic material may be filled in the hole 112a.

A plurality of sheets in a lower portion, for example at least two sheets 113 and 114 have holes 113a and 114a formed at a desired region, preferably center regions of the sheets, and a conductive material is filled in the holes 113a and 114a. As a result, the projecting electrode 400 is formed, which is exposed from inside to outside. That is, the projecting electrode 400 is formed such that it passes through the center regions of the plurality of laminated sheets 113 and 114 and is exposed to outside.

As described above, the circuit protection device according to another embodiment of the present invention comprises the coil patterns 310 to 390 which are formed by providing the patterned sheets 601 to 609 having a desired pattern engraved on each of the sheets 104 to 111 and filling the engraved pattern of the patterned sheets 601 to 609 with a conductive material. As a result, the thickness of the coil patterns 310 to 390 corresponds to the thickness of the patterned sheets 601 to 609. Therefore, the thickness of the coil patterns 310 to 390 may be larger than that of the coil patterns formed on the sheets 104 to 111, so that series resistance may be reduced.

Furthermore, the thickness of the coil patterns 310 to 390 may be increased without using the patterned sheets 601 to 609. For example, grooves having a desired depth are formed as a shape of the coil patterns 310 to 390 in the sheets 104 to 112 as shown in FIG. 6, and a conductive material is filled in the grooves to form the coil patterns 310 to 390. In this case, the depth and width of the grooves are completely uniform, and may be accurately controlled depending on the desired impedance.

The present invention has been described in detail with reference to the foregoing embodiments. However, these embodiments are provided only for example, but the present invention should not be limited to these embodiments. It is to be understood by one with ordinary skill in the art that various modifications may be made to the present invention without departing from the scopes of the present invention.

### DESCRIPTION OF THE NUMERICAL REFERENCES

100: sheet laminate

200: magnetic core

300: coil

400: projecting electrode

500: external electrode

1. A circuit protection device comprising a laminate having a plurality of sheets laminated; a magnetic core provided within the laminate; a coil provided within the laminate and configured to wind vertically and to wrap the magnetic core; a projecting electrode connected to the coil and projected to be exposed to the outside of the laminate; and an external electrode provided on the laminate and connected to the projecting electrode.

2. The circuit protection device of claim 1 wherein the magnetic core is formed by interconnecting first holes filled with a magnetic material in a plurality of selected sheets.

3. The circuit protection device of claim 2 wherein the coil is formed by forming a plurality of coil patterns and second holes filled with a conductive material, connected with the plurality of coil patterns, respectively, in a plurality of selected sheets, and by interconnecting the plurality of coil patterns by the second holes filled with a conductive material.

4. The circuit protection device of claim 3 wherein the coil patterns are formed in patterned sheets formed on the sheets.

5. The circuit protection device of claim 3 wherein the coil patterns are formed in grooves formed in the sheets.

6. The circuit protection device of claim 1 wherein the coil patterns, the first holes filled with a magnetic material and the second holes filled with a conductive material are individually formed on a plurality of selected sheets, the first holes filled with a magnetic material are interconnected to form the magnetic core, and the coil patterns are interconnected by the second holes filled with a conductive material to form the coil.

7. The circuit protection device of claim 1 wherein the plurality of sheets and the magnetic core have different magnetic permeability

8. The circuit protection device of claim 7 wherein the magnetic core has magnetic permeability higher than or lower than that of the plurality of sheets.

9. A circuit protection device comprising a plurality of sheets; first holes filled with a magnetic material formed in each of sheets selected among the plurality of sheets; coil patterns; and second holes filled with a conductive material, wherein the first holes filled with a magnetic material are interconnected to form a magnetic core, and the coil patterns are interconnected by the second holes filled with a conductive material to form a coil.

10. The circuit protection device of claim 9 wherein the circuit protection device further comprises a projecting electrode connected to the coil and exposed to outside through the laminate, and an external electrode provided on the laminate and connected to the projecting electrode.
